(19) United States
(12) Patent Application Publication
(10) Pub. No.: US 2006/0061283 A1
(43) Pub. Date: Mar. 23, 2006

(54) Electric lamp that is closed by means of a foil seal

(75) Inventor: Jurgen Graf, Augsburg (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCH GLUHLA, MUNCHEN (DE)

(21) Appl. No.: 11/225,097

(22) Filed: Sep. 14, 2005

(30) Foreign Application Priority Data
Sep. 21, 2004 (DE) 20 2004 014 711.4

(51) Int. Cl. H01J 61/36; H01J 17/18

(52) U.S. Cl. 313/623

(57) ABSTRACT

The elongate bulb (1) of a lamp, which defines a longitudinal axis (A), is closed at mutually opposite ends by sealing parts (6; 32), in which foils are inserted. The foils are axially folded, the cross section of the foil having the shape of a W with three bends, at least the central bend having a radius of curvature of from 0 to 0.6 mm.

### TECHNICAL FIELD

The invention relates to an electric lamp that is closed by means of a foil seal, having an elongate bulb that is sealed in a vacuum type fashion and defines a longitudinal axis and is closed at mutually opposite ends by sealing parts that include at least one foil that is folded parallel to the longitudinal direction, the foil being connected to supply leads. What is involved, in particular, is metal halide lamps, mercury high pressure discharge lamps, but also halogen incandescent lamps. The foil seal is mostly a pinch seal or a fused seal. The lamps can be closed at one end or two ends.

### BACKGROUND ART

U.S. Pat. No. 6,590,341 has already disclosed an electric lamp that is closed by means of a foil seal, the foil being bent in the shape of a V transverse to the longitudinal direction of the lamp axis. This bending serves the purpose of better reinforcement of the foil.

Other forms for improving the reinforcement are also known. U.S. Pat. No. 4,254,356 discloses a foil that is bent in the shape of an S transverse to the longitudinal direction. Something similar is exhibited by U.S. Pat. No. 3,515,931. U.S. Pat. No. 5,430,353 discloses a foil that is bent in corrugated fashion transverse to the longitudinal direction. The fastening is performed along the periphery of the contact elements.

### DISCLOSURE OF THE INVENTION

It is an object of the present invention to provide a lamp that is closed by means of a foil seal, having an elongate bulb that is sealed in a vacuum type fashion and defines a longitudinal axis and is closed at mutually opposite ends by sealing parts that include at least one foil that is folded parallel to the longitudinal direction, the foil being connected to supply leads, which lamp ensures a reliable and undamaged connection between the foil and supply lead.

This object is achieved by means of the following features:

at least the outer supply lead, which is fastened to the foil, is deformed such that its surface averted from the foil is incipiently flattened in the region of the overlap with the foil, while the foil and outer supply lead are matched to one another in their cross-sectional shape in the region of the surface, facing the foil, of the outer supply lead.

Particularly advantageous refinements are to be found in the dependent claims. The lamp closed by means of a foil seal has an inner bulb, sealed in a vacuum type fashion, in particular a discharge vessel that defines a longitudinal axis and that is closed at mutually opposite ends by sealing parts, a base being respectively fitted, in particular, on one end of the sealing part. The sealing part is a pinch seal or else a fuse seal. The luminous means in the interior of the lamp is a discharge arc between two electrodes, or a luminous element. It is connected in an electrically conducting fashion to the inner supply leads leading to it. Furthermore, the inner supply leads are connected to foils in the sealing part. These foils are connected, in turn, to outer supply leads that project outward from the sealing part. The two foils are embedded in one sealing part in the case of a bulb closed at one end. A foil is respectively embedded in a sealing part at both ends of the bulb in the case of a bulb closed at two ends.

According to the invention, at least one of the foils is bent away in a direction transverse to the longitudinal axis of the bulb, specifically so that it has three bends or folds in such a way that the foil forms a W in cross section. This improves the stiffness of the foil substantially such that even relatively long foils can be used without being distorted and bent, in particular the foils can have a length of between 3 and 25 mm, preferably large lengths of between 10 and 25 mm. The individual sides of the W are preferably intended to form an angle of at least 20°. A first embodiment is a sharp bend between the sides. It is easy to produce them, but gradual curves are more favorable in terms of production engineering. The fold points of the W consequently either have sharp bends with a radius of curvature of 0 or they exhibit gradual curves with a radius of curvature of up to 0.6 mm. The sealing behavior of the foil is best in this region of the radius of curvature.

A preferred embodiment of the angling away is a continuously differentiable curvature of the foil with a radius of curvature of from 0.25 to 0.6 mm. This has the advantage that the adherence of the glass on the foil is improved in the region of the curvature. In the event of an excessively sharp bend, the glass has difficulty penetrating into the region of the bend point, and this can easily lead to leaks. Consequently, the radius of curvature is preferably at least 0.25 mm. On the other hand, the curvature should not be too large, because otherwise the foil springs too strongly and is no longer stiff enough. The radius of curvature is therefore preferably at most 0.6 mm. The radius of curvature of all three bends is preferably the same.

In the case of the supply lead connected to the foil, it is particularly preferred for its contact region with the foil to be matched to the shape of the foil so as to produce a particularly safe and reliable connection between the foil and supply lead, because the contact surface is maximized. This principle can, of course, also be applied in the case of the second supply lead making contact with the foil.

It is known to have “spade-shaped” contact regions, incipiently flattened on both sides, of supply leads in order to improve the glass seal and contact with the foil. However, these have been used only in the case of flat foils. However, in the case of folded foils this concept would impair the stiffness of the foil because the flat front side of the foil would require too much room. It was therefore necessary to compromise between the stability of the foil (parameters of the W shape, such as spacing of the bend points, width of the foil, angle between the sides) and the stability of the supply lead, chiefly given by the diameter thereof. Two components are preferably matched to one another in such a way that the foil is relatively narrow. A typical value is a width of 1.5 to 2.5 mm, less in folded shape, typically up to 75 to 90% of the original width. One example is a flat foil of width 2 mm that is compressed in a fashion folded to 1.7 mm. By contrast, the supply lead is relatively wide, having a typical diameter of 0.8 mm. Ideal matching is now achieved by virtue of the fact that the supply lead is partially flattened in the contact region, specifically on its rear side, as it were. This means that it is flattened on one side. By contrast, on its other side (as it were on the front side, which faces the foil), it is approximately matched to the shape of the cross section of the foil, in particular it exhibits a hemispherical shape when the foil has a large radius of curvature in the folds, or it is V-shaped when the foil has sharp bends. The terms front side and rear side are not to be understood as if the two parts would need to be equivalent. For example, the proportion of the front side can be much greater than half the original thickness.

A typical application is metal halide lamps and halogen incandescent lamps.

Folding in the shape of a W with relatively sharp bends up to a radius of curvature of at most 0.6 mm increases the stiffness of the supply lead foils sufficiently without the welding electrodes that are required when producing the connection between the foil and supply lead being able to damage the foil. Consequently, a substantially improved defined position of the supply lead is achieved, and there is a reduction in waste caused by displacements of the supply leads and/or electrodes. The centering effect of the strongly folded foil is ever stronger with increasing angling away with regard to angle and number of bends. Thus, the V shape is superior to a flat foil, but the W shape, in turn, is far superior to a V shape. Consequently, at least three bends or curves are required. It is therefore not excluded to use further bends, at least a double W shape. It is also possible on the basis of these shapes to handle relatively long foils without a problem in the fabrication process, for example up to a length of 25 mm.

The foils have been bent up to now in the shape of a V. The V angle influences the flexural strength. This limitation based on the size of the V angle arose from the welding method using welding electrodes adjoining on top. The bent up legs of the foils touched the welding electrodes, and the latter damaged the edges of the foil. An angling away of no more than 20° was therefore possible. This limitation is now absent, because the ends are bent back.

According to the invention, the foil is folded parallel to the longitudinal direction, at least the outer supply lead, which is fastened on the foil, being deformed such that its surface averted from the foil is incipiently flattened in the region of the foil, while the foil and supply lead are matched to one another in their cross-sectional shape in the region of the surface, facing the foil, of the supply lead. This matching can be performed by a partial flattening of the supply lead, the film being bent exactly so that it matches the diameter of the supply lead in the region of the surface facing it. However, it is also possible for both partners, the supply lead and the foil, to be shaped, for example in that the foil is folded in a W-shaped fashion, and the cross section of the supply lead is pressed in the shape of a triangle such that it matches the central V of the foil cross section.

In a preferred embodiment, the foil and partially flattened supply lead are now coordinated with one another such that, in the region of the bends, at least in the central bend of the foil, the radius of curvature of the foil corresponds approximately, preferably with an accuracy of up to 30%, to the original diameter of the supply lead, the matched front side of the supply lead being in contact with the fold of the foil, while the flattened rear side of the supply lead is in contact with the surrounding glass. Ideal preconditions of making contact with the two different surrounding media, specifically the foil and glass, are respectively produced in this way for the supply lead.

A particular embodiment is, for example, a sharply bent W foil, the front side, facing the foil, of the contact region of the supply lead being of V-shaped configuration.

Thus, overall, the foil-facing part (front side) of the supply lead in the contact region is matched as far as possible to the bent shape of the foil (or vice versa), while the foil-averted part (rear side) of the supply lead in the contact region is intended to provide a glass seal that is as poor as possible, this being achieved at best by a flat, or possibly slightly cambered configuration of the rear side.

Owing to the resulting asymmetry, the sealing behavior of the V foils with a large V angle is very poor. By contrast, even given large angles the W foil remains approximately symmetrical and can therefore be sealed in a substantially simpler way. Large angles over 30°, for example up to 70°, have certainly been desired to date, but have not been capable of implementation, as explained above.

The transport of the electrode system formed from the foil and at least one supply lead connected thereto, in an automated production line is facilitated, since there is now no longer any need even for systems having long foils to be conveyed in a hanging fashion. In addition, the folded foil can more easily be threaded with a reduced width into the surrounding sleeve, mostly initially a glass tube that is then sealed by fusing or pinching. The invention is therefore particularly advantageous for foils that are to have a special length, in particular in the case of a ratio H of length L to width B of H=L/B≧3.

### BRIEF DESCRIPTION OF THE DRAWINGS

The invention is to be explained in more detail below with the aid of a number of exemplary embodiments. In the drawing:

FIG. 1 shows a halogen incandescent lamp in side view;

FIG. 2 shows an exemplary embodiment of a metal halide lamp in side view;

FIG. 3 shows a W foil with matched supply lead in cross section (FIG. 3a) and in plan view (FIG. 3b); and

FIGS. 4-6 show further exemplary embodiments of a W foil with matched supply lead.

### BEST MODE FOR CARRYING OUT THE INVENTION

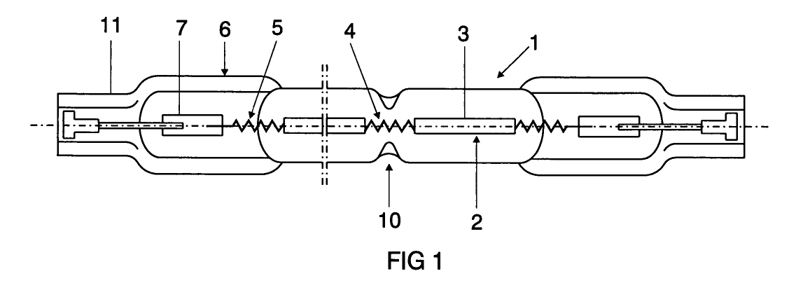

FIG. 1 shows a side view of a halogen incandescent lamp pinched at two ends. It comprises a cylindrical bulb 1 in which a luminous element 2 is arranged axially. It is held in the bulb 1 by knobs 10.

The luminous element 2 comprises luminous sections 3 of low pitch that are separated from one another by nonluminous sections 4 of high pitch. The ends 5 of the luminous element also comprise nonluminous sections of large pitch. In their function as inner supply lead, the ends 5 are directly embedded in the pinch seal 6 and connected there to a pinch foil 7.

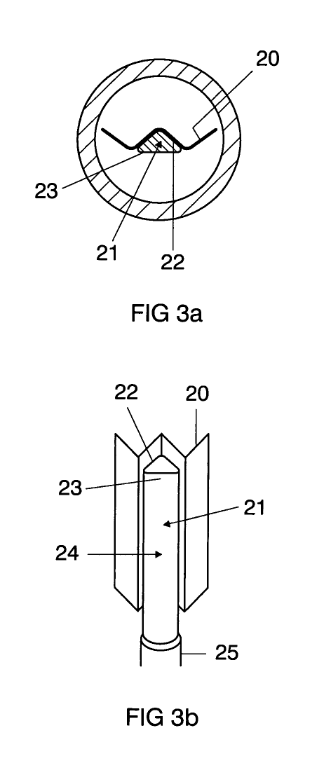

Integrally formed on the pinch seal 6 on the outside as base is a tubular glass sleeve 11 having an outside diameter of 7 mm and an inside diameter of 5 mm. The sleeve 11 is approximately 7 mm long. It is therefore narrower than the broad side of the pinch seal 6, but wider than the narrow side of the pinch seal 6. Details are shown in FIG. 3.

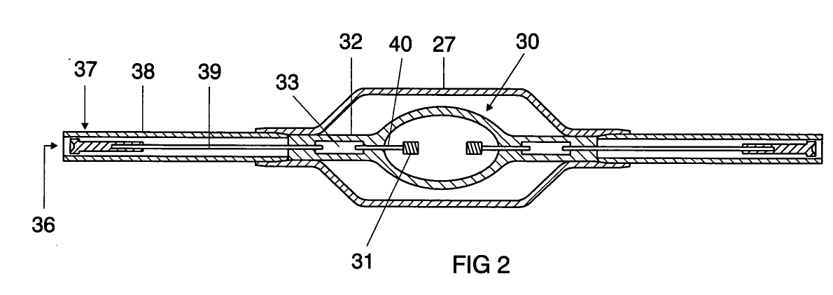

A further exemplary embodiment of a metal halide lamp is shown in FIG. 2. By contrast with FIG. 1, the quartz glass discharge vessel designed as a barrel element 30 encloses the two electrodes 31 in addition to a metal halide filling. The bulb ends are sealed by means of pinch seals 32 in which foils 33 are embedded. The inner supply leads 40 are each connected to the foil 33. The outer supply lead 39 is guided in a tubular sleeve 38 that here constitutes an elongation of the discharge vessel and ends in a bushing 37 of an integral base part 36. The bulging part of the discharge vessel is surrounded by an outer bulb 27. Details are shown in FIG. 3.

A detail of an exemplary embodiment of the connection between the foil and supply lead is shown in FIG. 3a. The cross section of the foil 20 has the shape of a W with sharp bends. As regards its contact region with the foil, the supply lead 21 is configured in the shape of a V at the front side 22, which faces the foil, while the part that is averted from the foil, and is thus the rear side 23, as it were, is flattened. This shape can be mechanically formed or milled. FIG. 3b shows a plan view, it being rendered clear that the remaining part 25 of the supply lead 21 outside the contact region 24 with the foil has an unaltered circular cross section.

The outer supply lead 40 can preferably be understood as supply lead 21, but the inner supply lead 39 can also be deformed at its ends facing the foil in the same or a similar way as the supply leads 40.

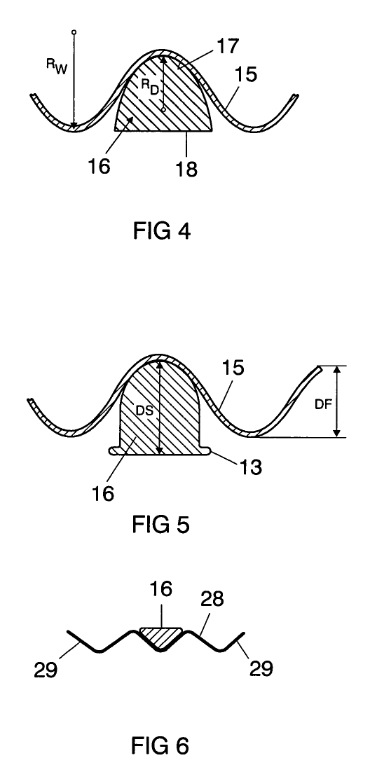

A detail of another exemplary embodiment is shown in FIG. 4. Here, the foil 15 is in the shape of a W with rounded folds. The radius of curvature RW of the foil is 0.35 mm. As regards its front side 17 in the contact region, the supply lead 16 is left approximately in the shape of a semicircle, while the rear side 18, which is averted from the foil, is flattened. This shape can be produced mechanically by means of a die, it being possible to set the thickness of the front side freely. The original diameter of the supply lead 16 is 0.8 mm, and so the radius of curvature RD of the front side, facing the foil, is 0.4 mm. However, the associated thickness of the front part can be greater than or less than half the original diameter.

FIG. 5 shows that lateral outgrowths 13 can also be produced during flattening on the basis of the mechanical stamping process. In particular, generally the total thickness DS of the flattened supply lead in the contact region is to correspond with the thickness DF of the folded foil, for example advantageously to less than 25% exactly, because then both the front side and the rear side find sufficient contacting surface with the foil and with the glass. The rear side need not be exactly flat, but can also be slightly cambered.

FIG. 6 shows a foil 28 with a supply lead 16, in which an additional stabilization of the foil is produced by additional wings 29 which are angled away. This embodiment is conceived for particularly large and wide foils.

What is claimed is:

1. An electric lamp that is closed by means of a foil seal, having an elongate bulb that is sealed in a vacuum type fashion and defines a longitudinal axis and is closed at mutually opposite ends by sealing parts that include at least one foil that is folded parallel to the longitudinal direction, the foil being connected to supply leads, wherein at least the outer supply lead, which is fastened to the foil, is deformed such that its surface averted from the foil is incipiently flattened in the region of the overlap with the foil, while the foil and outer supply lead are matched to one another in their cross-sectional shape in the region of the surface, facing the foil, of the outer supply lead.

2. The lamp as claimed in claim 1, wherein the matching is performed such that the foil is bent exactly so that it matches the diameter of the supply lead in the region of the surface facing it.

3. The lamp as claimed in claim 1, wherein the matching is performed such that both partners, the supply lead and foil, are shaped.

4. The lamp as claimed in claim 3, wherein the foil is folded in a W-shaped or V-shaped fashion, and that the cross section of the supply lead is pressed in the shape of a triangle such that it matches the central V of the foil cross section.

5. The lamp as claimed in claim 1, wherein the cross section of the foil has the shape of a W with three folds or bends, at least the central bend having a radius of curvature R of from 0 to 0.6 mm.

6. The lamp as claimed in claim 5, wherein all the folds have the same radius of curvature.

7. The lamp as claimed in claim 5, wherein the radius of curvature is 0.3 to 0.6 mm.

8. The lamp as claimed in claim 5, wherein the outer supply lead, which is in contact with the foil, is arranged in the central fold.

9. The lamp as claimed in claim 5, wherein the contact surface of the supply lead is approximately hemispherical, and is matched to the radius of curvature of the central fold of the foil.

10. The lamp as claimed in claim 5, wherein the contact surface of the supply lead has an approximately V-shaped cross section, and the fold of the foil exhibits a sharp bend.

11. The lamp as claimed in claim 1, wherein the length of the foil is between 3 and 25 mm.

12. The lamp as claimed in claim 1, wherein the rear side of the supply lead, averted from the foil, is substantially flat or slightly bent.

13. The lamp as claimed in claim 1, wherein the total thickness DS of the supply lead in the contact region of the foil corresponds approximately, in particular to 25% exactly, of the thickness DF of the folded foil.

14. The lamp as claimed in claim 1, wherein the inner supply lead is also deformed in a fashion similar to the outer one.
